(19) United States
(12) Patent Application Publication
(10) Pub. No.: US 2012/0162021 A1
(43) Pub. Date: Jun. 28, 2012

(54) CIRCULARLY POLARIZED ANTENNA WITH WIDE BEAM WIDTH

(75) Inventors: Kyong-Hee LEE, Daejeon (KR); Gwang-Ja Jin, Daejeon (KR); Moon-Kyun Oh, Daejeon (KR); Hae-Won Son, Jeonju-si (KR)

(73) Assignees: INDUSTRIAL COOPERATION FOUNDATION CHONBUK NATIONAL UNIVERSITY, Jeonju-si (KR); ELECTRONICS AND TELECOMMUNICATIONS RESEARCH INSTITUTE, Daejeon (KR)

(21) Appl. No.: 13/334,906

(22) Filed: Dec. 22, 2011

(30) Foreign Application Priority Data
Dec. 23, 2010 (KR) 10-2010-0133956

(51) Int. Cl. H01Q 9/04

(52) U.S. Cl. 343/700 MS

(57) ABSTRACT

Disclosed herein is a circularly polarized antenna with a wide beam width, in which four U-shaped metal strips are disposed in a circular shape, and four signals having the same magnitude and phase difference intervals of 90 degrees are fed to the respective metal strips so as to transceive circularly polarized waves. The disclosed circularly polarized antenna includes a ground plane, a central patch formed in the center of an upper surface of the ground plane, and a plurality of radiation patches disposed above the ground plane and around the central patch in a circular shape, wherein signals having the same magnitude and preset phase differences are fed to respective radiation patches.

### CROSS REFERENCE TO RELATED APPLICATION(S)

This application claims the benefit of Korean Patent Application No. 10-2010-0133956, filed on Dec. 23, 2010, which is hereby incorporated by reference in its entirety into this application.

### BACKGROUND OF THE INVENTION

1. Technical Field

The present invention relates generally to a circularly polarized antenna with a wide beam width, and more particularly, to a circularly polarized antenna with a wide beam width and bandwidth, in which a thickness thereof is minimized.

2. Description of the Related Art

Circularly polarized antennas having a wide beam width are used as global positioning system (GPS) receiving antennas, wireless local area network (LAN) antennas for ceiling installations, radio frequency identification (RFID) reader antennas for special use, and so forth.

To design the circularly polarized antennas that are mainly used at present, feeding is performed by shifting chamfering or feeding position from a normal position using a single microstrip patch antenna, so that a phase difference is given to current distribution formed at an edge of the microstrip patch antenna. Otherwise, circularly polarized radiation elements are arranged in a sequentially rotating pattern. Further, a structure based on slots and stacked parasite elements is also used.

The designs of the existing circularly polarized antennas have a disadvantage in that it is difficult to realize broadband characteristics. When the circularly polarized antennas are designed using a stacked structure in order to make up for this disadvantage, there is a structural problem with degradation of the axial ratio characteristic. Since radiation elements and feeders are arranged on the same plane of a dielectric substrate, it is easy to manufacture the antenna, but an electromagnetic wave radiation characteristic may be reduced due to a mutual interference effect. Meanwhile, even when a circularly polarized antenna is designed using the slots and stacked parasitic elements, the height of the circularly polarized antenna is increased.

In the case of the typical circularly polarized antennas, the structure of a patch antenna is frequently used. A patch antenna having a half wavelength size has a narrow beam width of about 70 degrees.

To increase the beam width of the patch antenna, the size of the patch is reduced so as to be still smaller than the half wavelength using a high-k substrate, or a ground plane having a three-dimensional structure such as a pyramid is used. However, when the size of the patch is reduced, the return loss bandwidth of the antenna is reduced. When the ground plane having a three-dimensional structure is used, the thickness of the antenna is increased.

### SUMMARY OF THE INVENTION

Accordingly, the present invention has been made keeping in mind the above problems occurring in the prior art, and an object of the present invention is to provide a circularly polarized antenna with a wide beam width, in which four U-shaped metal strips are disposed on a ground plane in a circular shape, and four signals having the same magnitude and phase difference intervals of 90 degrees are fed to the respective metal strips so as to transceive circularly polarized waves.

In order to accomplish the above objective, according to an aspect of the present invention, there is provided a circularly polarized antenna with a wide beam width, which comprises: a ground plane; a central patch formed in the center of an upper surface of the ground plane; and a plurality of radiation patches disposed above the ground plane and around the central patch in a circular shape, wherein signals having the same magnitude and preset phase differences are fed to the respective radiation patches.

Each radiation patch may have a feeder formed at a middle portion thereof to feed a signal.

Each radiation patch may be fed with a signal having a phase difference of 90 degrees from the feeder.

The plurality of radiation patches may be fed with signals having a phase difference of 90 degrees from the feeders.

The plurality of radiation patches may be spaced apart from the central patch.

The radiation patches may be short-circuited to the ground plane.

The radiation patches may be spaced apart from the ground plane by a plurality of metal posts that are disposed on the upper surface of the ground plane and are spaced apart from one another.

The radiation patches may be short-circuited to the ground plane by the plurality of metal posts.

The metal posts may include first metal posts that are connected to first ends of the radiation patches on first sides thereof and to the ground plane on second sides thereof, and second metal posts that are connected to the second ends of the radiation patches on first sides thereof and to the ground plane on second sides thereof.

The plurality of radiation patches may be formed in a “U” shape.

The plurality of radiation patches may be formed in a “V” shape.

The plurality of radiation patches may be formed in a “C” shape.

According to another aspect of the present invention, there is provided a circularly polarized antenna with a wide beam width, which comprises: a ground plane; a central patch formed in the center of an upper surface of the ground plane; a first radiation patch formed above the ground plane and spaced apart from the central patch; a second radiation patch formed above the ground plane and spaced apart from the central patch; a third radiation patch formed above the ground plane and spaced apart from the central patch; and a fourth radiation patch formed above the ground plane and spaced apart from the central patch. The first, second, third, and fourth radiation patches are disposed above the ground plane and around the central patch in a circular shape, and signals having the same magnitude and preset phase differences are fed to the first, second, third, and fourth radiation patches.

The first radiation patch may be fed with a signal having a phase difference of 0 degrees; the second radiation patch may be fed with a signal having a phase difference of 90 degrees; the third radiation patch may be fed with a signal having a phase difference of 180 degrees; and the fourth radiation patch may be fed with a signal having a phase difference of 270 degrees.

According to the present invention, the circularly polarized antenna with a wide beam width disposes four U-shaped metal strips on a ground plane in a circular shape, and feeds four signals having the same magnitude and phase difference intervals of 90 degrees to the respective metal strips, so that it can transceive circularly polarized waves with a wide beam width and a wide return loss bandwidth.

### BRIEF DESCRIPTION OF THE DRAWINGS

The above and other objectives, features, and advantages of the present invention will be more clearly understood from the following detailed description taken in conjunction with the accompanying drawings, in which:

FIG. 1 is a view for explaining a circularly polarized antenna with a wide beam width according to an exemplary embodiment of the present invention;

FIGS. 2 and 3 are views for explaining radiation patches of FIG. 1;

FIGS. 4 through 7 are views for explaining modifications of the circularly polarized antenna with a wide beam width according to an exemplary embodiment of the present invention; and

FIGS. 8 through 12 are views for explaining characteristics of the circularly polarized antenna with a wide beam width according to the embodiment of the present invention.

### DESCRIPTION OF THE PREFERRED EMBODIMENTS

Reference now will be made to exemplary embodiments of the present invention with reference to the drawings, in which the same reference numerals are used throughout to designate the same or similar components. Further, the detailed descriptions of known functions and constructions that unnecessarily obscure the subject matter of the present invention will be omitted.

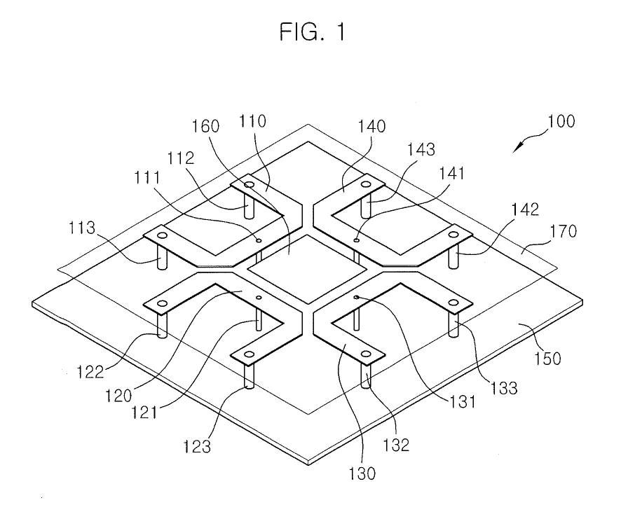

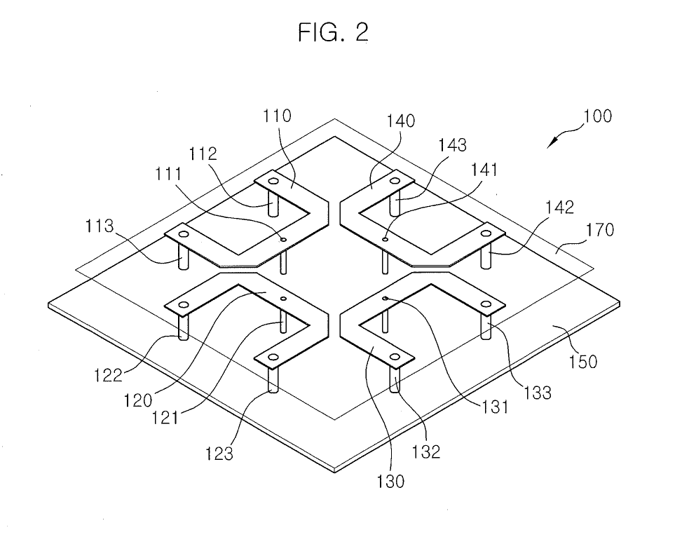

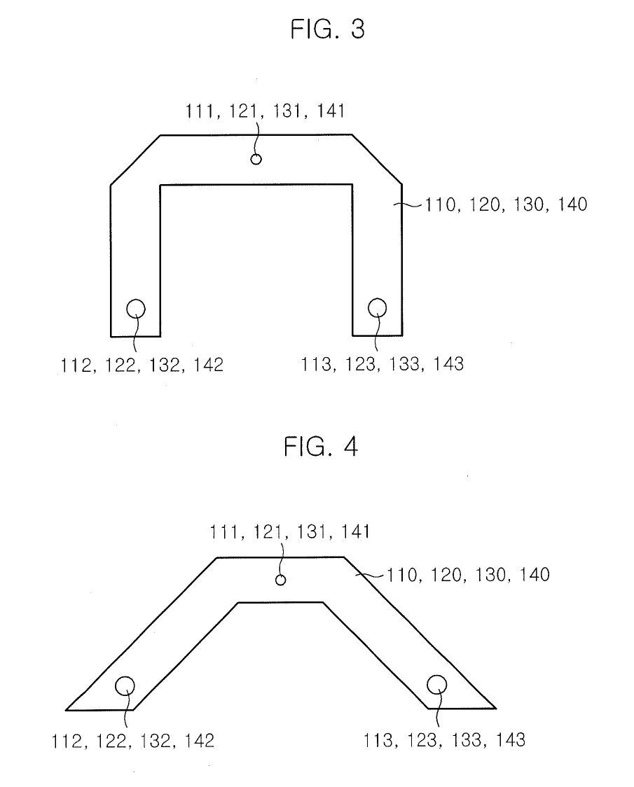

A circularly polarized antenna with a wide beam width according to an exemplary embodiment of the present invention will be described below in detail. FIG. 1 is a view for explaining a circularly polarized antenna with a wide beam width according to an exemplary embodiment of the present invention, FIGS. 2 and 3 are views for explaining radiation patches of FIG. 1, and FIGS. 4 through 7 are views for explaining modifications of the circularly polarized antenna with a wide beam width according to an exemplary embodiment of the present invention.

As shown in FIG. 1, the circularly polarized antenna with a wide beam width includes a ground plane 150, a central patch 160, a plurality of radiation patches 110, 120, 130, and 140, and metal posts.

The ground plane 150 is formed of a metal plate such as an aluminum plate.

The central patch 160 is formed in the center of the top surface of the ground plane 150. The central patch 160 is surrounded by the plurality of radiation patches 110, 120, 130, and 140, and is spaced apart from each of the radiation patches 110, 120, 130, and 140. The central patch 160 controls coupling information between the radiation patches 110, 120, 130 and 140 to facilitate adjustment of input impedance. Of course, as shown in FIG. 2, the central patch may be eliminated.

The central patch 160 is formed of an individual metal plate and is stacked in the center of the upper surface of the ground plane 150. Alternatively, the central patch 160 may be formed on a dielectric substrate 170 in such a manner that it is printed by, for instance, etching.

The radiation patches 110, 120, 130, and 140 are circularly disposed above the ground plane 150 centering the central patch 160. That is, the plurality of radiation patches 110, 120, 130, and 140 are disposed around the central patch 160 on an upper portion of the ground plane 150 in a circular shape. Here, the plurality of radiation patches 110, 120, 130, and 140 are spaced apart from the central patch 160. Each of the radiation patches 110, 120, 130, and 140 is formed of an individual metal plate and is stacked on the periphery of the upper surface of the ground plane 150. For example, the radiation patches 110, 120, 130, and 140 may be formed on the dielectric substrate 170 having the central patch 160 in such a manner that they are printed by, for instance, etching.

The radiation patches 110, 120, 130, and 140 are spaced apart from the ground plane 150 by a plurality of metal posts that are spaced apart from one another on the upper surface of the ground plane 150. Here, the radiation patches 110, 120, 130, and 140 are short-circuited to the ground plane 150. That is, the radiation patches 110, 120, 130, and 140 are short-circuited to the ground plane 150 by the plurality of metal posts.

As shown in FIG. 3, each of the radiation patches 110, 120, 130, and 140 is formed of a metal plate, particularly a metal strip having a “U” shape. The radiation patches 110, 120, 130, and 140 are provided with feeders 111, 121, 131, and 141 in the middles thereof. Opposite ends of each of the radiation patches 110, 120, 130, and 140 are coupled with the metal posts. The radiation patches 110, 120, 130, and 140 are disposed such that the opposite ends thereof are located on respective sides of the ground plane 150.

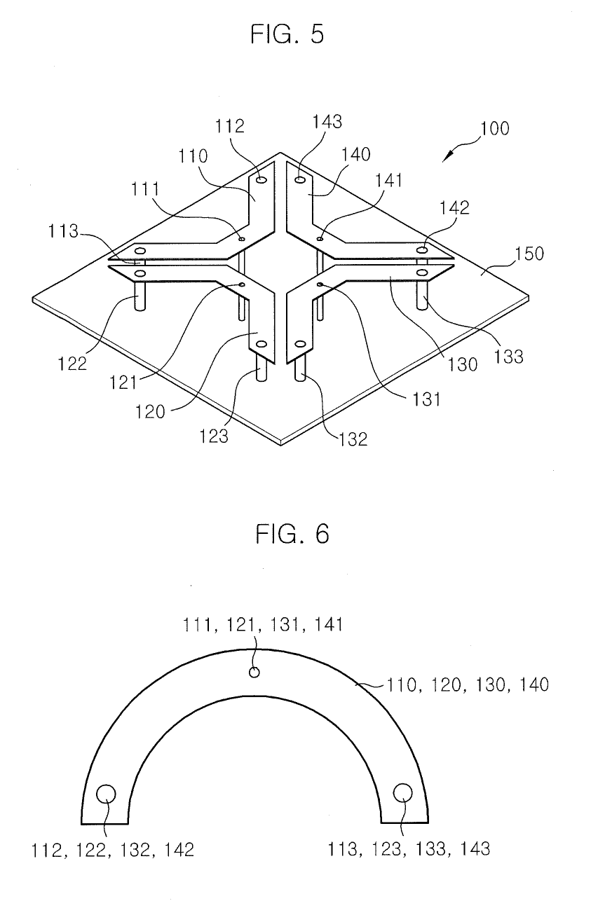

As shown in FIG. 4, each of the radiation patches 110, 120, 130, and 140 may be formed of a metal plate, particularly a metal strip having a “V” shape. Thus, as shown in FIG. 5, the circularly polarized antenna with a wide beam width is configured so that the opposite ends of the radiation patches 110, 120, 130, and 140 are disposed at the corners of the ground plane 150 (which correspond to opposite ends of the respective sides of the ground plane 150). In this case, the middle portions of the V-shaped radiation patches 110, 120, 130, and 140 may be modified depending on the shape of the central patch 160. For example, when the central patch 160 has a square shape, the middle portions of the V-shaped radiation patches 110, 120, 130, and 140 may be truncated.

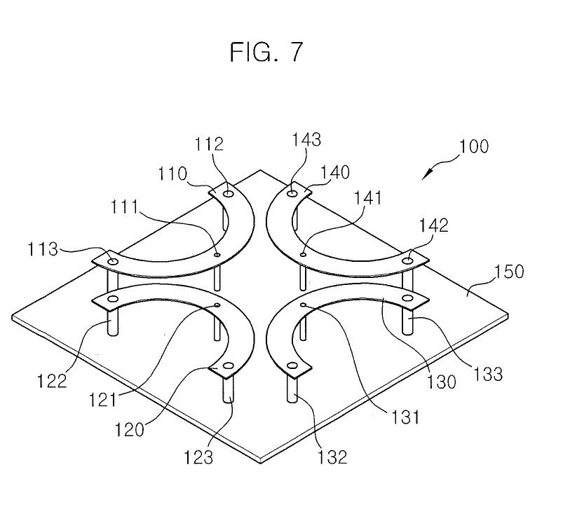

As shown in FIG. 6, each of the radiation patches 110, 120, 130, and 140 may be formed of a metal plate, particularly a metal strip having a “C” shape. Thus, as shown in FIG. 7, the circularly polarized antenna with a wide beam width is configured so that the opposite ends of the radiation patches 110, 120, 130, and 140 are disposed at the corners of the ground plane 150 (which correspond to the opposite ends of the respective sides of the ground plane 150). In this case, the radiation patches 110, 120, 130, and 140 are configured so that the middle portions thereof where the feeders 111, 121, 131, and 141 are formed are directed to the center of the ground plane 150.

The feeders 111, 121, 131, and 141 are formed at the middle portions of the radiation patches 110, 120, 130, and 140. That is, the feeders 111, 121, 131, and 141, which are also called feed probes, are formed at the middle portions of the metal strips formed into the radiation patches 110, 120, 130, and 140. Each of the radiation patches 110, 120, 130, and 140 is short-circuited to the ground plane 150 through the metal posts disposed at the opposite ends thereof. The plurality of radiation patches 110, 120, 130, and 140 are fed with signals having the same magnitude and preset phase differences from the feeders 111, 121, 131, and 141. For example, when the radiation patches 110, 120, 130, and 140 are configured as the first radiation patch 110, the second radiation patch 120, the third radiation patch 130, and the fourth radiation patch 140, the radiation patches 110, 120, 130 and 140 are excited by four signals whose magnitudes are equal to one another and whose phase differences have intervals of 90 degrees (i.e., four signals having phase differences of 0°, 90°, 180°, and 270°) respectively, thereby transmitting and receiving circularly polarized waves. In detail, the signal having the phase difference of 0 degrees is fed to the first radiation patch 110, and the signal having the phase difference of 90 degrees is fed to the second radiation patch 120. The signal having the phase difference of 180 degrees is fed to the third radiation patch 130, and the signal having the phase difference of 270 degrees is fed to the fourth radiation patch 140. Here, the input impedances of the radiation patches 110, 120, 130, and 140 are determined by lengths of the metal strips formed in the radiation patches 110, 120, 130, and 140, positions of the metal posts, and electromagnetic coupling degrees with the other radiation elements.

The metal posts are disposed at the opposite ends of the radiation patches 110, 120, 130, and 140, so the radiation patches 110, 120, 130, and 140 are separated from the ground plane 150. The metal posts cause the radiation patches 110, 120, 130, and 140 to be short-circuited to the ground plane 150. To this end, the metal posts are classified into first metal posts 112, 122, 132, and 142 that are connected to first ends of the radiation patches 110, 120, 130, and 140 on first sides thereof and to the ground plane 150 on the second sides thereof, and second metal posts 113, 123, 133 and 143 that are connected to the second ends of the radiation patches 110, 120, 130, and 140 on first sides thereof and to the ground plane 150 on the second sides thereof.

The radiation patches 110, 120, 130, and 140 may be modified in various shapes in addition to the aforementioned examples. Further, the shapes and positions of the metal posts and the feeders 111, 121, 131, and 141 may be modified by various methods that are well-known to those skilled in the art.

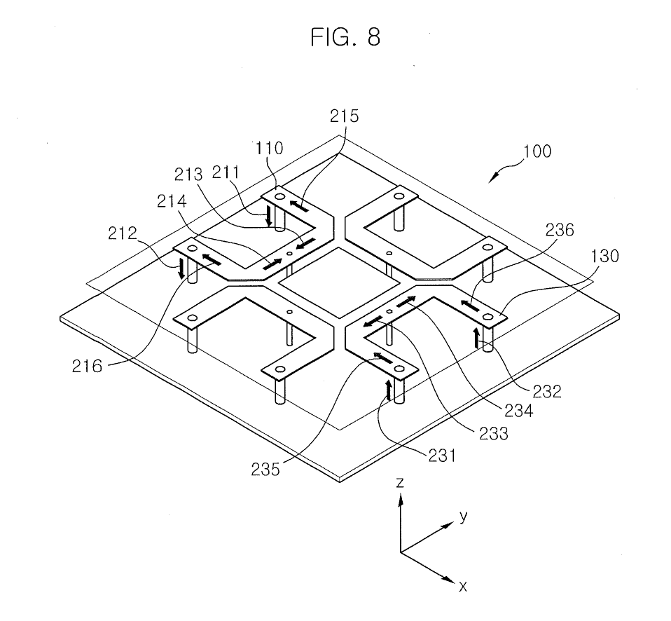

Hereinafter, characteristics of the circularly polarized antenna with a wide beam width according to the embodiment of the present invention will be described in detail with reference to the attached drawings. FIGS. 8 through 12 are views for explaining characteristics of the circularly polarized antenna with a wide beam width according to the embodiment of the present invention.

FIG. 8 illustrates the directions of currents generated when two signals having the same magnitude and a phase difference of 180 degrees are applied to the two opposite radiation patches (i.e. the first and third radiation patches 110 and 130) in the circularly polarized antenna with a wide beam width which is constituted of the first radiation patch 110, the second radiation patch 120, the third radiation patch 130, and the fourth radiation patch 140.

As shown in FIG. 8, the currents 211, 212, 231, and 232 that flow to the metal posts of the two radiation patches 110 and 130 in a vertical direction (i.e. in a z-axial direction) have directions opposite to each other. Thus, radiated electric fields caused in ±y-axial directions by the currents are offset.

However, the metal posts of the two radiation patches 110 and 130 are spaced apart from each other by a distance of an approximately half wavelength in an x-axial direction. As such, the radiated electric fields caused by the z-axial currents flowing to the metal posts of the two radiation patches 110 and 130 are mutually reinforced to form a high gain in ±x-axial directions.

Meanwhile, among horizontal current components flowing along the metal strips of the two radiations patches 110 and 130, y-axial components 213, 214, 233, and 234 flow in opposite directions, and thus fail to contribute to the radiation of radio waves.

In contrast, among horizontal current components flowing along the metal strips of the two radiation patches 110 and 130, x-axial components 215, 216, 235, and 236 flow in the same direction. As such, the radiated electric fields caused by the z-axial components are mutually reinforced to form a high gain in ±y-axial and +z-axial directions.

In this manner, the vertical current components flowing to the metal posts of the two radiation patches 110 and 130 form the high gain in the ±x-axial directions, and the horizontal current components flowing along the metal strips form the high gain in the ±y-axial and +z-axial directions. As a result, an entire radiation pattern caused by the two radiation patches 110 and 130 has a wide beam width within the E-plane (x-z plane) and H-plane (y-z plane).

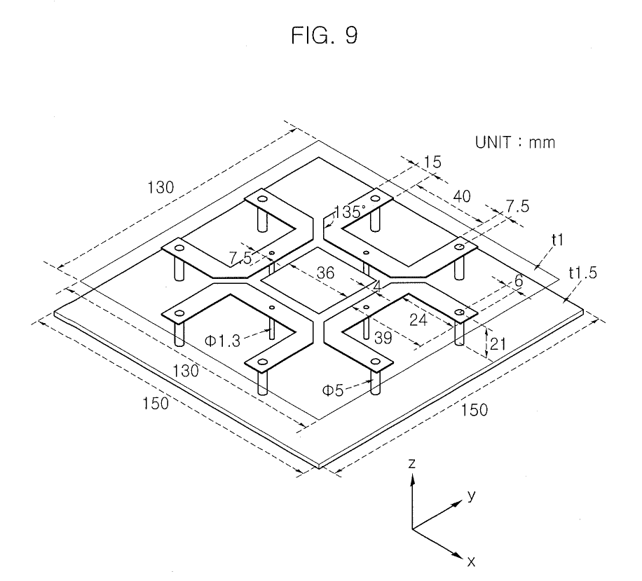

FIG. 9 shows detailed dimensions of the antenna used for a simulation. It is assumed that the four radiation patches 110, 120, 130, and 140 and the central patch 160 are formed on the dielectric substrate 170 having a thickness of 1 mm and a relative dielectric constant of 4.3 by etching.

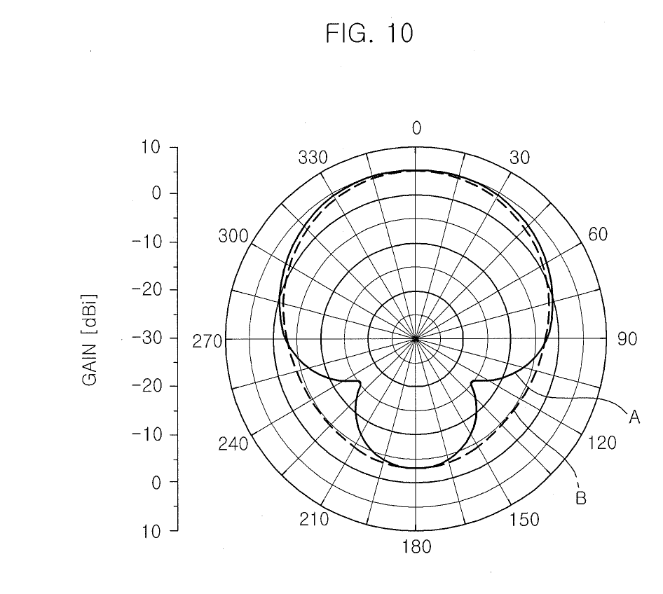

FIG. 10 shows the results of simulating the radiation pattern at a frequency of 915 MHz when two signals having the same magnitude and a phase difference of 180 degrees are applied to the two radiation patches 110 and 130. As shown in FIG. 10, the beam width of the E-plane (x-z plane) is 114 degrees (A of FIG. 10), and the beam width of the H-plane (y-z plane) is 98 degrees (B of FIG. 10). Thus, it can be found that the circularly polarized antenna with a wide beam width according to the embodiment of the present invention has a very wide beam width.

The circularly polarized antenna with a wide beam width generates circularly polarized waves by disposing the two pairs of radiation patches 110 and 130, and 120 and 140, having the radiation pattern (i.e. the radiation pattern shown in FIG. 10) so as to be orthogonal to each other, and feeding the four signals having the same magnitude and the phase difference intervals of 90 degrees (i.e. the four signals having the phase differences of 0 degrees, 90 degrees, 180 degrees, and 270 degrees) to the respective radiation patches 110, 120, 130, and 140.

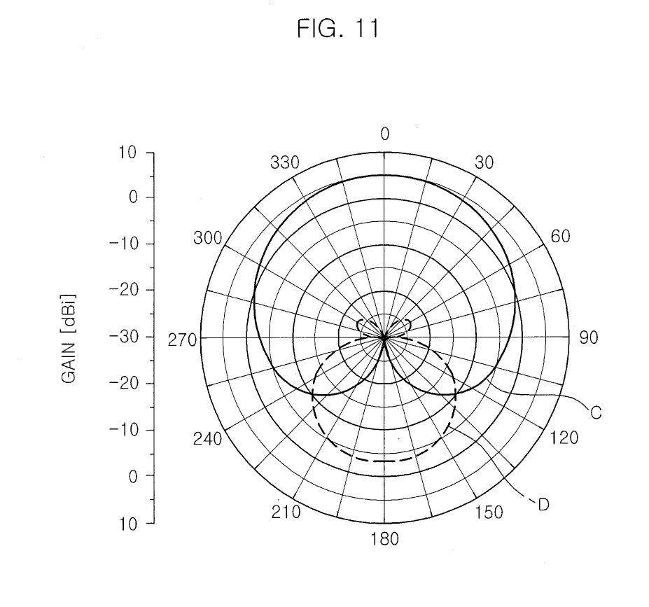

FIG. 11 shows the results of simulating the radiation pattern at a frequency of 915 MHz when four signals having the same magnitude and phase differences of 0 degrees, 90 degrees, 180 degrees, and 270 degrees are applied to the four radiation patches 110, 120, 130, and 140 constituting the circularly polarized antenna with a wide beam width. It can be found that the maximum gain in a boresight direction is 5.1 dBic and that the beam width is 106 degrees. The symbol “C” of FIG. 11 refers to right-hand circular polarization (RHCP) and the symbol “D” refers to left-hand circular polarization (LHCP).

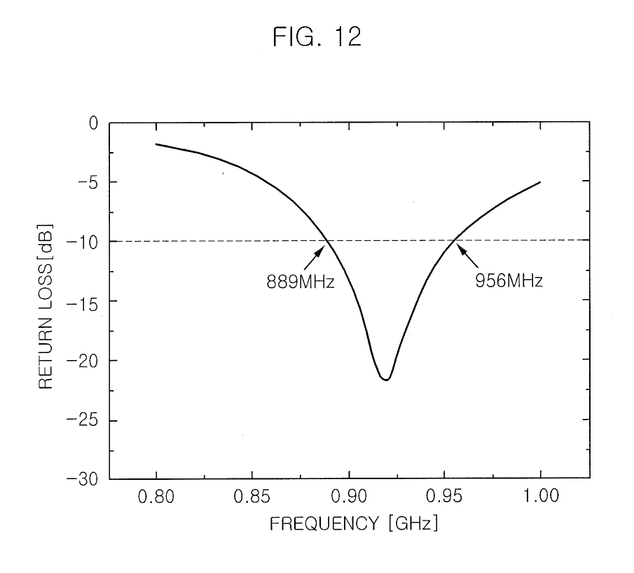

FIG. 12 shows the results of simulating return loss at a feed port of one of the radiation patches 110, 120, 130, and 140 in the circularly polarized antenna with a wide beam width. It can be found that a return loss of 10 dB or more occurs at a wide bandwidth of about 7.3%.

As described above, the inventive circularly polarized antenna has a wide beam width and a wide bandwidth, and is able to transceive the circularly polarized waves. However, to feed the four signals having the same magnitude and phase differences of 0 degrees, 90 degrees, 180 degrees, and 270 degrees to the four radiation patches 110, 120, 130, and 140, a four-point feed circuit is required. This can be realized using various methods that are well-known to those skilled in the art.

Although the exemplary embodiments of the present invention have been disclosed for illustrative purposes, those skilled in the art will appreciate that various modifications, additions, and substitutions are possible without departing from the scope and spirit of the invention as disclosed in the accompanying claims.

What is claimed is:

1. A circularly polarized antenna with a wide beam width, comprising:
a ground plane;
a central patch formed in the center of an upper surface of the ground plane; and
a plurality of radiation patches disposed above the ground plane and around the central patch in a circular shape,
wherein signals having the same magnitude and preset phase differences are fed to the respective radiation patches.

2. The circularly polarized antenna as set forth in claim 1, wherein each radiation patch has a feeder formed at a middle portion thereof to feed a signal.

3. The circularly polarized antenna as set forth in claim 2, wherein each radiation patch is fed with a signal having a phase difference of 90 degrees from the feeder.

4. The circularly polarized antenna as set forth in claim 1, wherein the plurality of radiation patches are fed with signals having a phase difference of 90 degrees from the feeders.

5. The circularly polarized antenna as set forth in claim 1, wherein the plurality of radiation patches are spaced apart from the central patch.

6. The circularly polarized antenna as set forth in claim 1, wherein the radiation patches are short-circuited to the ground plane.

7. The circularly polarized antenna as set forth in claim 1, wherein the radiation patches are spaced apart from the ground plane by a plurality of metal posts that are disposed on the upper surface of the ground plane and are spaced apart from one another.

8. The circularly polarized antenna as set forth in claim 7, wherein the radiation patches are short-circuited to the ground plane by the plurality of metal posts.

9. The circularly polarized antenna as set forth in claim 7, wherein the metal posts include first metal posts that are connected to first ends of the radiation patches on first sides thereof and to the ground plane on second sides thereof and second metal posts that are connected to the second ends of the radiation patches on first sides thereof and to the ground plane on second sides thereof.

10. The circularly polarized antenna as set forth in claim 1, wherein the plurality of radiation patches are formed in a “U” shape.

11. The circularly polarized antenna as set forth in claim 1, wherein the plurality of radiation patches are formed in a “V” shape.

12. The circularly polarized antenna as set forth in claim 1, wherein the plurality of radiation patches are formed in a “C” shape.

13. A circularly polarized antenna with a wide beam width, comprising:
a ground plane;
a central patch formed in the center of an upper surface of the ground plane;
a first radiation patch formed above the ground plane and spaced apart from the central patch;
a second radiation patch formed above the ground plane and spaced apart from the central patch;
a third radiation patch formed above the ground plane and spaced apart from the central patch; and
a fourth radiation patch formed above the ground plane and spaced apart from the central patch,
wherein the first, second, third, and fourth radiation patches are disposed above the ground plane and around the central patch in a circular shape, and
signals having the same magnitude and preset phase differences are fed to the first, second, third, and fourth radiation patches.

14. The circularly polarized antenna as set forth in claim 13, wherein:
the first radiation patch is fed with a signal having a phase difference of 0 degrees;
the second radiation patch is fed with a signal having a phase difference of 90 degrees;
the third radiation patch is fed with a signal having a phase difference of 180 degrees; and
the fourth radiation patch is fed with a signal having a phase difference of 270 degrees.
